(19) United States
(12) Patent Application Publication
(10) Pub. No.: US 2005/0140981 A1
(43) Pub. Date: Jun. 30, 2005

(54) Measurement of optical properties

(76) Inventor: Rudolf Waelti, Liefeld (CH)

Correspondence Address: BIRCH STEWART KOLASCH & BIRCH, PO BOX 747, FALLS CHURCH, VA, 22040-0747, US

(21) Appl. No.: 10/511,150

(22) PCT Filed: Apr. 17, 2003
(86) PCT No.: PCT/CH03/00257

(30) Foreign Application Priority Data
Apr. 18, 2002 (CH) 05302

(51) Int. Cl. G01B 9/02

(52) U.S. Cl. 356/479

(57) ABSTRACT

The invention relates to an ophtalmological examination and/or treatment station that comprises, in the form of modules, a lighting device, an observation device, an optical measuring system, an evaluation unit and a patient module which is positioned immediately in front of the patient's eye. The patient module can be optically linked with the locally remote lighting device and the likewise remote measuring system in a detachable manner. The measuring system forming part of the ophthalmological examination and/or treatment station comprises an optical system with a short-coherent radiation source (9) of the Michelson interferometer-type. An optically transparent and/or diffusive, reflecting object (1) can be introduced into the measuring arm (7) of said optical system and the reference arm (5) thereof has a wavelength variation unit (39) for modifying the runtime and at last two reflectors (31a, 31b) which produce a runtime difference. The measuring system is used to measure optical properties of at least two spaced-apart areas (2a, 2b) of the transparent and/or diffusive object (1) at a measuring time in the subsecond range. The inventive measuring system allows in vivo measurements of distances, thicknesses, surface characteristics etc. which comprise measurements at different locations of an object, in an optimum manner, i.e., with reduced measurement errors.

### TECHNICAL FIELD

The invention relates to an ophthalmological examination and/or treatment station with, inter alia, a measuring system, and also to a measuring system defined in the precharacterizing part of patent claim 7 and used independently or as part of this examination and/or treatment station, and furthermore to a method defined in the precharacterizing part of patent claim 10 and intended for automatic measurement of optical properties using this measuring system.

In ophthalmological examination and treatment stations, such as, for example, a photo slit lamp 900 P-BQ from the company Haag-Streit AG or a slit lamp described in EP-A-0 916 306, individual elements, such as a lens support unit, a microscope, a lighting top part, etc., can be exchanged.

### OBJECT OF THE INVENTION

The object of the invention is not one of arranging several subunits, which may possibly require servicing, exchangeably on an ophthalmological apparatus, but of creating an ophthalmological examination and treatment station which can be used in a versatile manner, preferably by simple modification, and which in particular avoids large arrangements in front of the patient's eye.

### SOLUTION TO THE OBJECT

This object is achieved by virtue of the fact that the ophthalmological examination and/or treatment station is of a modular design, i.e. has a number of exchangeable units. Because of this modular design, the examination and/or treatment station can be constructed and modified such that it takes up the space of just one apparatus but makes it possible to achieve the functionality of a number of different individual apparatus. The modular design comprises a lighting device, an observation device, an evaluation unit and a measuring system, and also a patient module to be arranged directly in front of the patient's eye. Measuring system and lighting device are often of a voluminous design or generate heat or air currents which inconvenience the patient. Here, they are arranged remote from the patient and are connected to the patient module via optical fibres. The connection of the optical fibres to the patient module is made detachable. By virtue of this detachability, different measuring systems and lighting devices can be easily connected up, depending on which examinations or observations are to be performed. The connection is effected via fibre couplers. In the patient module, only collimator optics are then arranged contiguous to the fibre couplers, these collimator optics converting the radiation signal issuing from a fibre into a free-space beam or coupling radiation signals into the fibre ends.

The patient module will preferably be provided with a display element which is connected to the evaluation unit via a detachable electrical signal line. Measurement results, treatment instructions, etc., for the physician can then be presented on the display element.

The observation device can now be designed such that it is part of the patient module. That is to say, the physician holds the patient module in front of the patient's eye or places it on the surface of the eye and looks through it onto/into the eye.

However, it is also possible for an electronic observation device to be provided with image signals that can be evaluated. This is achieved with an eyepiece arranged in the patient module and with an objective lens for viewing the eye.

The observation device then has an image detecting element (CCD) arranged in the patient module, and an optical system projecting an area of the eye to be viewed onto an image detecting element. The optical system is likewise arranged in the patient module. Image detecting element and optical system can also be formed in a pair and at a distance from one another in order to permit stereoscopic observation. The image detecting element is then connected to the remote evaluation unit via an electrical signal line. Images received with the image detecting unit can also be represented on the aforementioned display element which is arranged on the patient module or integrated in the latter.

The patient module can be provided with a housing which, in terms of its dimensions, is similar to a commercially available contact lens, possibly with a slightly greater cross section (volume requirement). However, the spatial configuration of the patient module should be as small as possible and take up only a small amount of space in front of the patient's eye. Voluminous components in front of the eye generally inconvenience the patient. However, a handle or alignment unit can also be provided as a holding means. With this alignment unit, the patient module can then be positioned with respect to the eye.

The measurement and/or observation device can be connected to an evaluation unit for evaluation of measured data, said evaluation unit preferably being computer-assisted. The evaluation unit can also be connected via a data network to other data memories containing retrievable data, so that the determined and/or evaluated data can be processed with said other data. This permits good diagnosis, since values and information can be called up from data banks.

Using a measuring system as a modular element, the ophthalmological examination and treatment station can now be modified in such a way that, as has already been mentioned, it can be used for measurement of optical properties of at least two spatially separate areas in a transparent and/or diffusive object and also for measuring thickness, distance and/or profile. The measurement of thickness, distance and/or profile is performed by means of short-coherence reflectometry. If the object used is an eye, then the station is an ophthalmological examination and treatment station; however, any other desired transparent and/or diffusive objects can also be measured.

The transparency of objects depends on their wavelength-dependent attenuation coefficient α[cm⁻¹] and on their thickness or the predefined measurement distance d. Objects are designated as being transparent when their transmission factor T=exp(−α.d) still lies in the measurement range of the interferometers described below, and, in said interferometers described below, on account of the to and fro movement of the radiation, the transmission is T². In diffusive objects, the radiation is strongly scattered, not necessarily absorbed. Examples of diffusive objects are milk glass plates, Delrin, organic tissue (skin, human and animal organs, plant parts, etc.).

Short-coherent reflectometry has generally been performed for precise, rapid and noninvasive imaging. Typically, in an optical system with a Michelson interferometer, the beam from a radiation source has been split by a beam splitter into a reference beam and a measurement beam. A radiation source with a short coherence length has generally been chosen. Splitting the beam into a reference beam and measurement beam, and recombining these beams, has been done by means of a beam splitter and using fibre optic paths with a fibre coupler. The optical path length change in the reference arm has been able to be obtained by moving a reference mirror on a translation stage. However, a rotating transparent cube is advantageously used, as was described in WO 96/35100. Only if the path length difference was smaller than the coherence length of the radiation from the radiation source did an interference pattern arise after recombining the reflected reference beam and measurement beam. The interference pattern was applied to a photodetector which measured the radiation intensity during the change in the mirror position. Since the frequency of the radiation of the reflected reference beam experienced a dual displacement on account of the mirror displacement, the interference signal could, as is set out below, be evaluated by electronic means, as described for example in WO 99/22198, by increasing the signal-to-noise ratio.

However, measurement errors occurred if distances which required at least two measurement procedures were to be measured in optically transparent objects or in objects allowing diffuse transmission of optical radiation, and if the objects could be fixed only with difficulty, or inadequately, within the required measurement tolerance over the entire measurement cycle. These problems arose in particular in in vivo measurements.

EP-A-0 932 021 discloses a device with a laser interferometer for determining the evenness of a surface. In the known device, a laser beam was divided by a beam splitter into two beams. These two beams were oriented parallel at a predefined angle using optical deflection means. The two parallel beams struck a pair of beam deflection elements (prisms) arranged on a holder. Each of these deflection elements diverted each beam in such a way that it was reflected in a laterally offset manner, but parallel to the incident beam. Each of the reflected beams was sent to a respective reflector. The reflectors were connected in a fixed position to the beam splitter. Each of the beams striking the reflectors was reflected back into itself and, after further back-reflection via the beam deflection elements, was combined by the beam splitter and irradiated into a detector with interference. If the holder was now moved, the interference pattern in the detector changed, as a result of which the evenness of a surface could be determined.

The known device was complex in terms of its optical structure and permitted only determination of the evenness of a surface.

### FURTHER OBJECT OF THE INVENTION

It is an object of the invention to make available a method and to provide a device (system) which can preferably be used in a structure for an ophthalmological examination and/or treatment station, and with which method and device it is possible in particular to perform in vivo measurements of distances, thicknesses, surface contours, etc., which include measurements at different locations of an object, in an optimum manner, i.e. with reduced measurement errors.

### SOLUTION OF THE OBJECT

As regards the method, the object is achieved by the fact that the optical properties of at least two spatially separate areas in a transparent and/or diffusive object, or eye, are determined at a measurement time in the subsecond range. To do this, a Michelson-type arrangement is used with which the short-coherent radiation issuing from a radiation source is divided into a measurement beam and a reference beam. The measurement beam irradiates the areas in question. A transit time change is imposed on the reference beam, and the latter is reflected at at least two reflectors which produce a transit time difference. The reflected reference beam is then combined interfering with the reflected measurement beam. The combined beam is detected, and the detected signal is evaluated for distance measurement.

To measure optical properties at a measurement time in the subsecond range (necessary for in vivo measurement) for at least two spatially separate areas in a transparent and/or diffusive object, as is necessary for measuring distance, length, thickness and profile, the object is irradiated with a number of measurement beams, simultaneously or in quick succession, which correspond to the number of areas. The expression “in” an object is intended to signify that the areas can be situated at locations both in the object and on the object, e.g. laterally offset. The measurement beams, which have different transit times, interfere with reference beams which, allowing for a certain tolerance, likewise have different transit times.

The transit time difference in the reference beam path corresponds to an optical spacing of two spatial points (areas) in relation to the direction of propagation of the measurement beam, where at least one of the spatial points reflects at least slightly (typically at least 10⁻⁴% of the radiation intensity). The measurement beams can thus lie over one another (measurement of thickness, distance, length), extend parallel to one another (surface profile, etc.) or be at any desired angles with respect to one another (measurement of thickness, distance, etc., at a defined angle to a reference surface).

To generate the transit time change of the reference beam, which preferably takes place periodically, several methods are possible. For example, this can be done using a rotating “cube” with partially reflecting side surfaces, as described in WO 96/35100. However, the reflectors can also execute a linear displacement, preferably periodically. The “cube” described in WO 96/35100 provides a transit time change which is linear and takes place periodically and virtually across the entire course. By contrast, on account of the accelerations to be performed, the linearly moved mirrors provide no linear transit time changes.

Now, compared to a “common” Michelson interferometer, we no longer operate in the reference arm with just one reflected beam, but instead with a plurality of beam reflections dependent on the number of areas to be measured. These beam reflections will be advantageously configured in such a way that the part-beams are always reflected back into themselves, although this is not essential. An optical system of this kind is simple to design.

In order to achieve said plurality of beam reflections, several mirrors offset with respect to one another in the beam direction can now be arranged as a so-called stepped mirror. The stepped mirror can now be illuminated in its entirety with the reference beam, or the individual mirrors one after another. If, for example, the “cube” already mentioned above is used, this affords a lateral beam deflection, so that one mirror after another is hit as the cube rotates.

However, it is also possible to use a rotating diaphragm, or a diaphragm which is moved linearly via the mirrors. Further variants are described below.

In order preferably to achieve a high spatial resolution, the measurement beam will be focussed onto the areas to be measured. Illustrative embodiments are likewise described below.

After effecting the path difference or differences, the measurement beams are preferably combined to form a single beam configuration with a single optical axis in order to permit thickness measurement. The beam configuration can also be moved across the object, in particular periodically. This results in lateral scanning. This scanning, with storage of the determined values, can be used to establish profiles. Instead of focussing the two measurement beams along an optical axis, at least two measurement beams can in each case also extend at a distance alongside one another and be focussed in order to determine a surface profile.

The measurement beams have a short coherence length compared to the area spacings, in particular to the area spacings starting from a reference location. The measurement beams can also have radiation frequencies in each case differing from one another. However, it is then necessary to use a plurality of radiation sources. It is also possible to operate with only one radiation source and obtain splitting via filters. This, however, results in a broadband loss; some of the components also have to be provided with an expensive coating.

Instead of different radiation frequencies, or in addition to these, the measurement beams can have mutually different polarization states, which permits a simpler construction. The measurement beams will preferably also be focussed into the area to be measured or areas to be measured. Since a Michelson interferometer-type optical arrangement is used, the instantaneous positions of the reflecting elements can serve as reference sites in the reference arm. The actual position can be used for this, or another value linked to the reference site, for example the position of turning of the rotating cube which is described in WO 96/35100.

The measurement is performed on an optically transparent and/or diffusive object which can be brought into the measuring arm. Instead of an optically transparent and/or diffusive object, it is also possible to work with an object whose surface is highly reflecting. In the case of a reflecting object, the method according to the invention can be used in particular to determine the surface profile of said object. However, the object can be optically transparent and/or diffusive and have an (at least several percent) reflecting surface. In this case, it is then possible to determine surfaces and also thicknesses and their profiles.

In addition to using areas (sites) lying “behind one another” in the object in order to measure thickness, it is of course also possible to use areas (sites) lying “alongside one another” in order to determine surface curvatures and surface profiles.

The offset arrangement of the reflectors is made approximately such that it corresponds to an expected measurement result of a thickness, distance, etc., to be determined, while allowing for a certain tolerance. With the path variation unit in the reference arm, only the unknown part (to be determined) of the thickness, of the distance, etc., now has to be determined. If, for example, the actual length of a human eye is to be determined, it is already known that eyes have an optical length of 34 mm, with a length tolerance of ±4 mm. The offset can in this case be adjusted to 34 mm, and the path variation unit can be used to undertake a variation of only 8 mm.

With the device (system) described below and its embodiment variants, it is possible to measure not only the eye length (centrally, peripherally), but also the anterior chamber depth (centrally, peripherally), the corneal thickness (centrally, peripherally), the lens thickness (centrally, peripherally) and the vitreous body depth, and also corresponding surface profiles (topography) of the anterior face of the cornea, the posterior face of the cornea, the anterior face of the lens, the posterior face of the lens, and the retina. In this way it is also possible to determine the radii of curvature of, for example, the anterior face of the cornea, the posterior face of the cornea, the anterior face of the lens and the posterior face of the lens. For this purpose, the measurement beam defined for the eye surface as object surface is focussed “somewhere” between the anterior face of the cornea and the posterior face of the lens. By means of this “compromise”, the reflection can then be detected on the anterior face of the cornea, the posterior face of the cornea, the anterior face of the lens and the posterior face of the lens. The distance between the posterior face of the cornea and the anterior face of the lens is then the anterior chamber depth. A condition for this measurement, however, is that the optical “travel” (ca. 8 mm) of the path variation unit is large enough to permit scanning from the anterior face of the cornea to the posterior face of the lens.

A single measurement thus processes the reflections at several areas almost simultaneously. However, in order to be able to distinguish between the individual reflections in terms of the measurements, the measurement beams have different optical properties, for example different direction of polarization, different wavelength, etc. However, it is also possible to work with non-distinguishable beams and, by changing the offset of the reflectors, to bring the two interference signals into congruence. In this case, the offset is then equal to the sought spacing, thickness, etc. The use of non-distinguishable beams leads to a sensitivity loss.

Depending on the number of measurement beams used, one or more distances can be determined by one measurement.

As is described in WO 96/35100, the path length changes in the reference arm can be made using a rotating transparent cube in front of a stationary reflector. Such a cube is easily able to rotate at over 10 Hz. That is to say, in most measurements the object to be measured can be regarded as being at rest, without special measures having to be taken to fix it.

Further alternative embodiments of the invention and their advantages will become evident from the text below. It should be noted in general that the optical devices designated below as having beam splitters are able to divide beams, but also to join together two beams.

### BRIEF DESCRIPTION OF THE DRAWINGS

Examples of the ophthalmological examination and/or treatment station according to the invention, and of the measuring system according to the invention with which the method according to the invention can be carried out, are explained in more detail below with reference to drawings in which:

FIG. 1 shows a block diagram of a modular ophthalmological examination and/or treatment station according to the invention, inter alia with a measuring system,

FIG. 2 shows an embodiment variant of a patient module which is to be placed in front of the patient's eye and is part of the examination and/or treatment station shown in FIG. 1,

FIG. 3 shows another variant of the patient module shown in FIG. 1,

FIG. 4 shows an optical block diagram of an illustrative design of a measuring system according to the invention, as can be used preferably in the examination and/or treatment station shown in the block diagram in FIG. 1,

FIG. 5 shows a variant of the reflector arrangement in the reference arm of the optical construction shown in FIG. 4, of the measuring system that can be used in FIG. 4,

FIG. 6 shows a further variant of the reflector arrangement in the reference arm analogous to FIG. 5,

FIG. 7 shows a variant of the measuring system shown in FIG. 4,

FIG. 8 shows a side view of the prism arrangement used in FIG. 7, in viewing direction V indicated there,

FIG. 9 shows a variant of the measuring systems shown in FIGS. 4 and 7,

FIG. 10 shows a measurement beam trajectory for profile determination directly in front of the object to be measured,

FIG. 11 shows a variant of the measuring systems shown in FIGS. 4, 7 and 9, with a plurality of measurement beams,

FIG. 12 shows an enlarged view of the measurement beam trajectory of the measuring system shown in FIG. 11, in the area of the object to be measured (e.g. eye),

FIG. 13 shows an optical block diagram of a variant of the measuring system according to the invention in which the radiation for the most part travels in optical fibres, the surface of the eye, for example, being shown here turned through 90° in order to represent the points of impact of the beams,

FIG. 14 shows a schematic representation of a stereo microscope of a slit lamp apparatus with a measurement beam path in the centre channel of the microscope, and

FIG. 15 shows a slit lamp apparatus with an adapter which can be fitted onto the microscope.

### EMBODIMENTS OF THE INVENTION

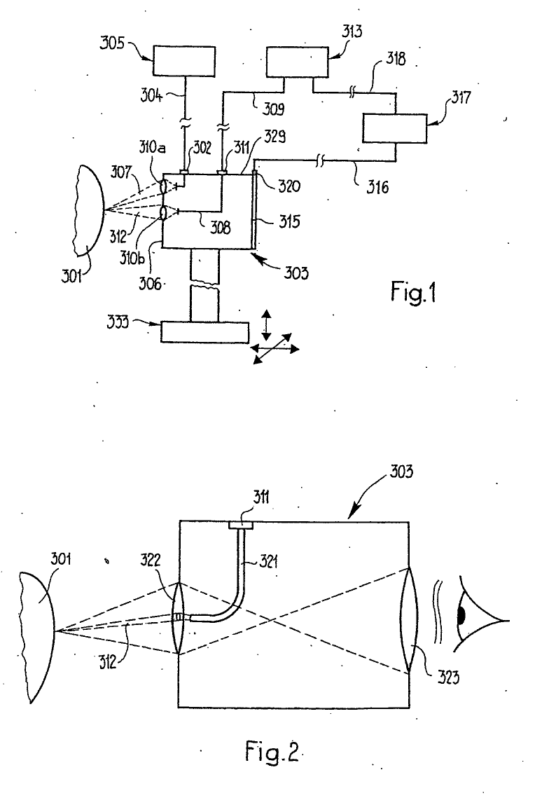

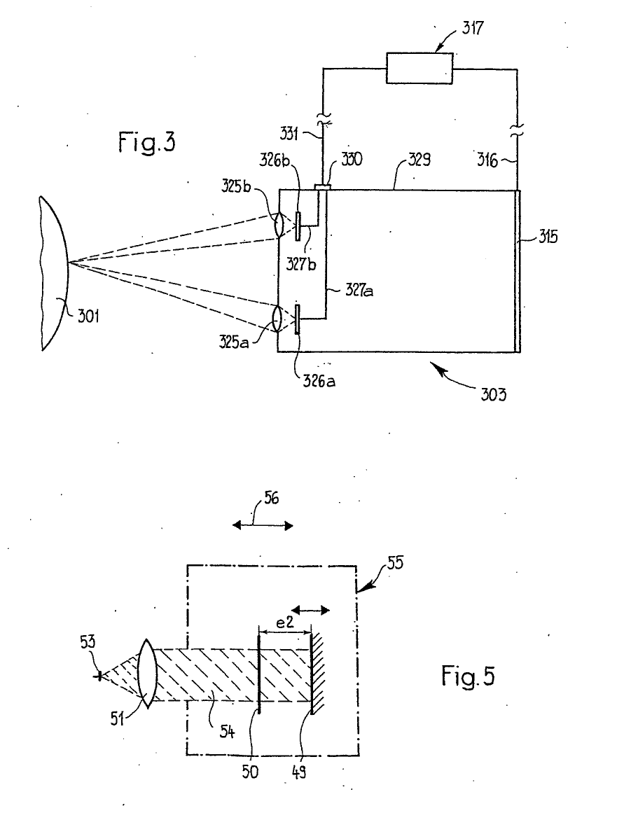

The ophthalmological examination and/or treatment station shown in one embodiment variant in a “block diagram” in FIG. 1 is of a modular design. A patient module 303 can be positioned directly in front of a patient's eye 301. A lighting device 305 is connected to the patient module 303 via an optical fibre 304 which is detachable via a fibre coupler 302. Arranged in the lighting device 305 there is a radiation source (not shown) whose radiation is delivered via the fibre 304 to the patient module and is then projected from the latter, by a collimator lens 310a, as a free-space beam 307 onto/into the eye 301. An observation device arranged in the patient module 303 is described below and is shown schematically in FIGS. 2 and 3.

The patient module 303 interacts with a measuring system described below. The measuring system has an optical fibre 309, which is here part of a measuring arm of a Michelson interferometer-type measuring system. The fibre 309 is likewise detachably connected to the patient module 303 by means of a coupler 311. The radiation of the fibre 309 is directed as a free-space beam 312 from the patient module 303 into/onto the eye 301. The free-space beam 312 is generated by a collimator lens 310b. The collimator lens 310b is arranged in front of the end of a fibre 308 which extends from the fibre coupler 311 in the wall 329 of the patient module 303 as far as the housing wall 306 adjacent to the patient's eye 301.

All the remaining components of the measuring system are arranged remote from the patient module 303, the arrangement with the remaining components being indicated symbolically as block 313.

A display element 315 is arranged on the side of the patient module 303 directed away from the eye 301. This display element 315 is detachably connected in signalling terms to an evaluation unit 317 by means of electrical coupling 320 and an electrical connection 316. The evaluation unit 317 is connected via a further electrical signal line 318 to the block 313.

The eye 301 can now be observed directly, as is shown in FIG. 2. Issuing from the fibre coupler 311 in the measuring arm, a further fibre 321 is here routed through the objective lens 322 for direct observation. At the end of the fibre 321 distant from the coupler 311, a collimator lens 323 is then arranged which focuses the free-space beam 312 onto the desired area in or on the eye 301. The free-space beam for lighting is omitted in FIG. 2 for the sake of clarity.

Instead of direct observation, electronic aids can also be used for the observation, as is shown in FIG. 3. FIG. 3 shows a stereoscopic observation with two optical systems 325a and 325b whose images of an eye area fall onto an image detecting element (e.g. CCD) 326a or 326b, respectively. The electrical signal outputs 327a and 327b lead to an electrical coupling 330 which is arranged in the housing wall 329 of the patient module 303 and on which a signal cable 331 for the evaluation unit 317 fits detachably. The image optionally processed in the evaluation unit 317 can then be sent for presentation to the display element 315 via the connection 316.

The radiation of the lighting device 305 can be guided via its own optical fibre 304 to the patient module 303. However, it can also preferably be coupled into the fibre 309 in the block 313.

The patient module 303 is positioned with a holding device 333 in front of the patient's eye 301. The holding device can be a handle or it can be an adjustment device which permits a change of position horizontally and vertically in a controlled manner.

The patient module 303 will be configured as small as possible in order not to inconvenience the patient by placing voluminous components in the area of the eye. An ideal volume would be approximately the size of conventional contact lenses. However, because of the collimator lenses that are to be installed, the device will turn out slightly larger.

By virtue of the modular design of the examination and/or treatment station, the latter can take up the space of just one single apparatus and have the functionality of a number of different individual apparatus and, in addition to its versatility, only a small device is placed in front of the patient's eye and does not inconvenience the patient in any way.

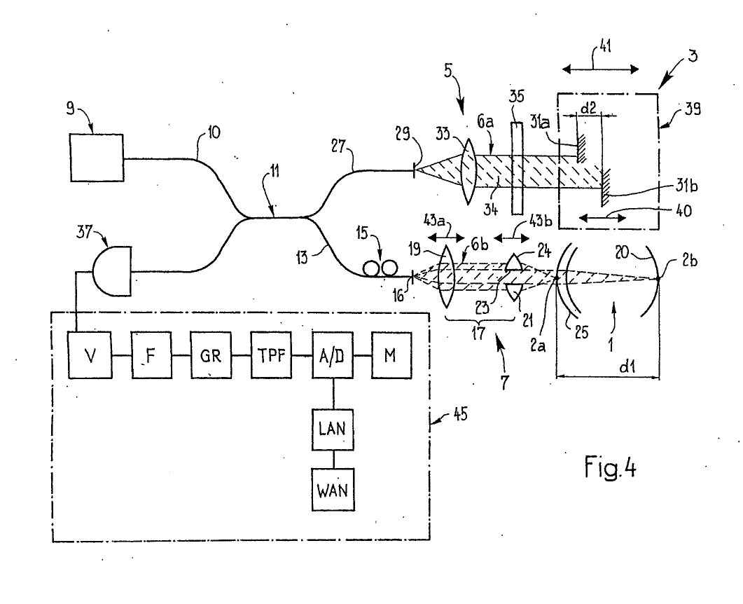

FIG. 4 shows an illustrative embodiment of a measuring system according to the invention with a Michelson interferometer-type optical system. This measuring system can preferably be used together with the abovementioned patient module 303 in a modular measurement and treatment structure. In the optical measuring system, use is chiefly made of fibre-optic components which permit considerable flexibility in terms of space and permit working in a relatively rough environment. In the illustrative embodiments described below, for ease of understanding, only two areas 2a and 2b in the object 1 to be measured, in this case an eye, are measured in the measuring arm 7. The work is performed with free-space beams 6a and 6b only directly in front of the measurement object 1, in this case an eye, and in front of the mirror arrangement 3 in the reference arm 5. The optical system of the measuring system has, in addition to the reference arm 5, a measuring arm 7 in which the object 1 to be measured is arranged. A radiation source 9 transmits short-coherent radiation which is guided in an optical fibre 10 to a fibre coupler 11. The coherence length of the radiation is chosen to be shorter than the distances to be measured in the object 1 which are described below. As radiation source 9, it is possible, for example, to use a superluminescence diode or another broadband radiation source (light). The so-called source beam issuing from the radiation source 9 and guided in the fibre 10 is divided by the fibre coupler 11 into a reference beam and a measurement beam. After the fibre coupler 11, the measurement beam travels in an optical fibre 13 with a fibre-technology polarization controller 15. At the end 16 of the fibre 13 distant from the fibre coupler 11, the measurement beam then emerges as free-space beam 6b. The emerging free-space beam 6b is focussed by a lens system 17 onto/into the two measurement areas 2a and 2b, respectively. Depending on the distance to the measurement areas, the free-space beam 6b can be collimated to a parallel beam and then focussed onto the two measurement areas 2a and 2b or, as is shown in FIG. 4, focussed directly into the areas 2a and 2b.

FIG. 4 serves for determining the length of the eye. The free-space beam 6b is here, for example, focussed by a first focussing lens 19 of the lens system 17 onto the measurement area 2b on the retina 20. The lens system 17 has a further focussing lens 21 which is arranged at a distance from the focussing lens 17 in the direction towards the eye 1. The central area of the lens 21 has an aperture 23 through which the beam focussed onto the area 2b can pass unimpeded. The edge areas 24 of the lens 21 then focus the beam, “pre-focussed” through the lens 19, onto the measurement area 2a on the corneal anterior surface 25.

The “hole lens” 21 will preferably be designed to be displaceable in the direction of propagation of the measurement beam 6b. In this way it is ensured that, even in the case of a visual defect, (e.g. myopia or hyperopia) of the eye 1 to be examined, the measurement beam can be focussed at least approximately onto the retina 20.

Instead of the arrangement with a “hole lens”, a diffractive element can also be used.

Starting from the fibre coupler 11, the reference arm 5 likewise has a fibre 27 connected to it, and the free-space beam 6a emerges at the end 29 of the fibre 27 distant from the fibre coupler 11. The reference arm 5 further includes an arrangement 3 of a plurality of reflectors which have the effect that the free-space beam 6a incident on them is reflected back into itself. The individual reflectors are mutually offset in such a way that the beams incident on them acquire a transit time difference in the reference arm 5. In the example shown here, only two reflectors 31a and 31b are present, since the aim is to determine only a distance d₁ between two areas 2a and 2b in the object 1 (measurement object: eye). If several areas are to be measured together, it is of course necessary to provide the appropriate number of reflectors. An offset d₂ between the two reflectors 31a and 31b corresponds to a distance value d₁ to be expected, allowing for tolerance, between the two areas 2a and 2b in the eye 1.

The free-space reference beam 6a emerging from the fibre end 29 is widened by a collimator lens 33 to the extent that both reflectors 31a and 31b can be illuminated. In the collimated beam path 34 after the lens 33, a rotating diaphragm 35 is arranged which is designed in such a way that the reflector 31a is first irradiated, then the reflector 31b. It is possible to do without this rotating diaphragm 35. It can be used, however, in order to achieve an unequivocal relationship to the measurement signals. It could happen, for instance, that the reflection properties of the anterior and posterior measurement areas 2a and 2b are almost identical. In such cases it is not always possible to decide whether the first measurement signal, produced by an interfering superposition in the fibre coupler 11 and detected by a photodetector 37, originates from the anterior measurement area 2a or from the posterior measurement area 2b. In the case of an eye, it is normally possible to decide this without the use of such a diaphragm 35 because the measurement signals from the anterior part of the eye (cornea, anterior chamber, lens) and from the retina 20 clearly differ.

Both reflectors 31a and 31b can, however, be adjusted relative to one another on a base 39, in the manner of a stepped mirror, as is indicated by a double arrow 40. As is indicated by the other double arrow 41, the base 39 can be periodically moved perpendicular to the incident reference free-space beam 6a. All reflectors 31a and 31b are highly reflecting and are designed lying parallel to one another. The base 39 can, for example, be a vibrating loudspeaker membrane.

If the length of the eye is to be determined, the two reflectors 31a and 31b are arranged at a distance d₂ which is the typical eye length of 34 mm to be expected (tolerance±4 mm). The periodic movement of the reflector arrangement 3, i.e. of the base 39, according to double arrow 41, then takes place with several oscillations per minute (e.g. at 10 Hz). Whenever the optical path lengths in the reference arm 5 and in the measuring arm 7 between the fibre coupler 11 and reflector 31a and the fibre coupler 11 and the measurement area 2a, or between the fibre coupler 11 and the reflector 31b and the fibre coupler 11 and the measurement area 2b, are the same length, the detector 37 detects an interference signal. Since the excursion of the base 39 is known, the eye length d₁ can thus be determined.

If another distance d₁ is to be determined, the two reflectors 31a and 31b are set to a different mutual spacing d₂ and the base 39 is then moved periodically to and fro. When setting the distance d₂, account simply has to be taken of the fact that the setting tolerance must lie in the travel range of the base 39, since otherwise no interference signal is obtained.

The great advantage of the system according to the invention being used in ophthalmology is in particular that only the lens system 17 is present in front of the patient's eye. Moreover, no moved parts are present. The lens system 17 can be of a small and easy-to-use design. It can, for example, be accommodated in a cylinder-type handle. The two lenses 19 and 21 of the lens system 17 are also made adjustable in order to permit adaptation of the focussing to the corresponding areas which are to be measured. The possibility of adjustment of the two lenses 19 and 21 is indicated in FIG. 4 by the two double arrows 43a and 43b. If more than two areas are to be measured at once, more focussing lenses are then to be provided accordingly.

Starting from the fibre end 16, the first lens is designed solid, analogously to the lens 19, and all subsequent lenses have an aperture for the beam from the preceding lens or lenses.

The interference signals detected by the detector 37 travel as electrical signals to evaluation electronics 45. These evaluation electronics 45 will entail greater or lesser complexity depending on the attainable electrical signal strength and the attainable signal-to-noise ratio. In general, the evaluation electronics 45 have a pre-amplifier V, a signal filter F, a rectifier GR and a low-pass filter TPF. The electrically processed analog signals are preferably converted to digital signals for further processing or storage. The digitalized signals can also be compared via networks [Local Area Network LAN (e.g. Ethernet) or Wide Area Network WAN (e.g. Internet)] with other data or sent for evaluation. The determined data could also be presented in suitable form on a monitor M.

As is shown in FIG. 4, the reflectors can be arranged as n elements 31a, 31b, etc., alongside one another with a mutual offset e₂ analogous to the offset d₂ in the direction relative to the direction of the reference beam incidence. However, the reflectors can also be arranged one after the other in the manner indicated in FIG. 5. In the same way as in FIG. 4, and in order not to clutter the drawing, FIG. 5 also shows just two reflectors 49 and 50. In analogy to the representation in FIG. 4, a collimator lens 51 is also present here for collimating the free-space reference beam emerging from a fibre end 53. A rotating diaphragm 35, as used in FIG. 4, is not required here. The collimated free-space reference beam 54 now impinges on a first low-reflecting reflector 50 and thereafter on a 100% reflecting reflector 49. Both reflectors 49 and 50 are arranged at a distance e₂ analogous to the distance d₂. The partial reflection of the reflector 50 is then chosen corresponding to the reflection of the measurement areas. Both reflectors 49 and 50 are also arranged in this case on a common base 55. The base 55, like the base 39, executes periodic oscillation for transit time change (indicated by a double arrow 56). Measurement length adaptation can then be achieved by displacement of the two reflectors 49 and 50 relative to one another. If several areas are to be measured or brought into relationship with one another, several reflectors are used, and the rearmost reflector should always be a 100% mirror. The partial reflections of the reflectors in front of it are to be adapted to one another and to the reflection of the measurement area.

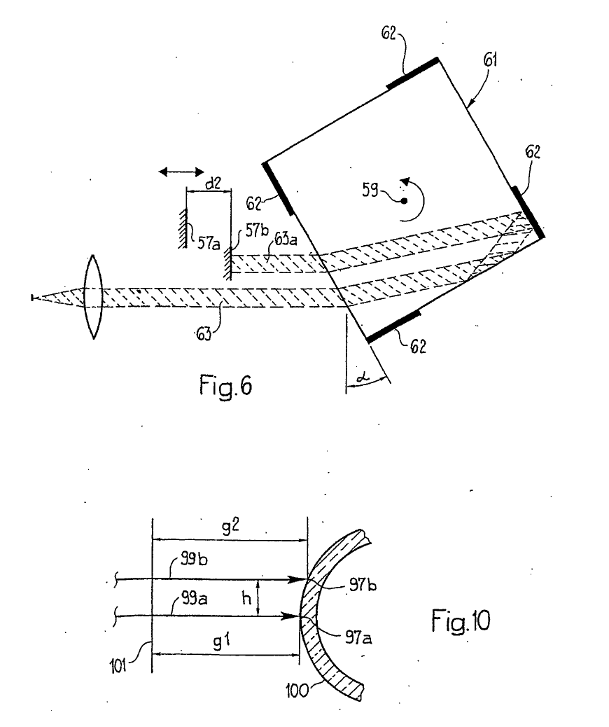

In addition to a reflector system, as is shown in FIGS. 4 and 5, a further example of a system is shown in FIG. 6. In contrast to the comments made above, the reflectors in the system shown in FIG. 6, here designated 57a and 57b, are stationary during the measurement procedure. A movement of the reflectors 57a and 57b is executed only if the measurement structure changes. A transparent cube 61, rotating about its centre axis 59 and acting as a so-called path variation element, is placed in front of the reflectors 57a and 57b. A path variation element 61 of this kind is described in WO 96/35100. The outsides of the cube have reflecting partial surfaces 62 on which the collimated reference free-space beam 63 passing into the cube 61 is reflected with a beam path as indicated in FIG. 6. The rotation of the cube results in a movement of the beam 63a emerging from the cube perpendicular to the surface of the reflectors 57a and 57b, i.e. the emerging beam migrates to and fro between the two reflectors 57a and 57b. Irradiation of the offset reflectors 57a and 57b chronologically after one another is possible also with the rotating diaphragm 35 shown in FIG. 4, but in that case there is a considerable radiation loss in the reference beam. This radiation attenuation is completely eliminated in the arrangement with the rotating cube 61.

Instead of the two reflectors 57a and 57b, a transparent rectangular parallelepiped (not shown) with two opposite walls parallel to one another can also be used. The side of the rectangular parallelepiped facing towards the rotating cube 61 is designed to be partially reflecting and partially transmitting, and the side of the rectangular parallelipiped facing away is totally reflecting. The distance between the two faces of the rectangular parallelepiped is d₂. The rectangular parallelipiped will preferably be made of glass. It can be mounted in a fixed position and also arranged on a translation stage in order to be able to permit adaptation to different measurement procedures. In measurements carried out on the human eye, d₂ is chosen corresponding to the eye length.

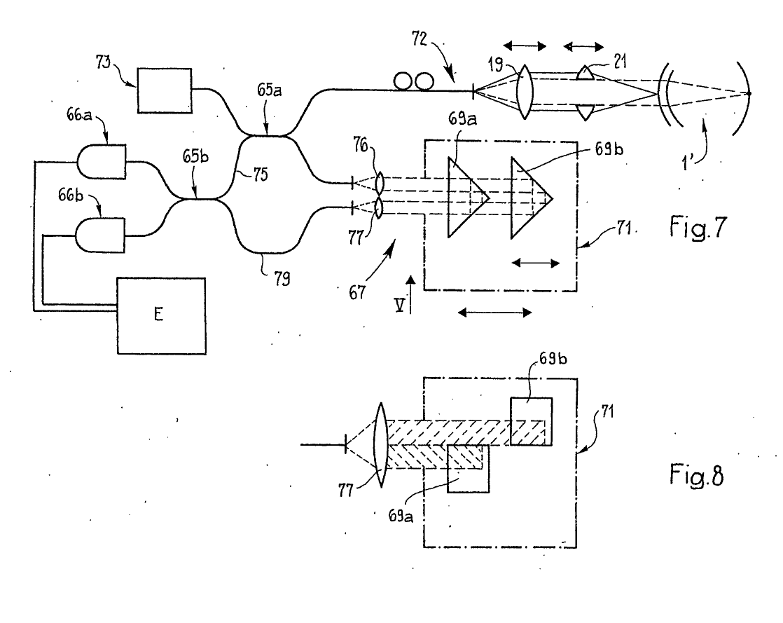

FIG. 7 shows a variant embodiment of the optical system illustrated in FIG. 4. In contrast to the system shown in FIG. 4, two fibre couplers 65a and 65b and two detectors 66a and 66b are present here. Also, instead of the plane reflectors 31a and 31b used in FIG. 4, the reference arm 67 now has two prisms 69a and 69b which act as retroreflectors and are also in this case arranged on a base 71 which can move by oscillation. In order to generate the transit time difference, the two prisms 69a and 69b are offset one behind the other and alongside one another, as is shown by the side view in FIG. 8. The lateral offset shown in the side view is necessary, since otherwise the prism 69a would cover the prism 69b. The measuring arm 72 is designed analogously to the measuring arm 7 in FIG. 4.

In FIG. 7, the short-coherent radiation issuing from a radiation source 73 analogous to the radiation source 9 is divided in the fibre coupler 65a into the measuring arm 72 and the reference arm 67. The radiation reflected from the areas to be measured in the object, here indicated by 1′, is guided, after the fibre coupler 65a, to the fibre coupler 65b via a fibre 75. The reference free-space beam reflected, i.e. diverted, by the prisms 69a and 69b and collimated by the lens 76 passes via a focussing lens 77 into a fibre 79 leading to the fibre coupler 65b. Interfering superposition of the radiation from the measuring arm 72 with that from the reference arm 67 then takes place in the fibre coupler 65b. Detection is effected with the two detectors 66a and 66b. By using two detectors 66a and 66b, the signal-to-noise ratio and, consequently, the measurement sensitivity can be greatly improved.

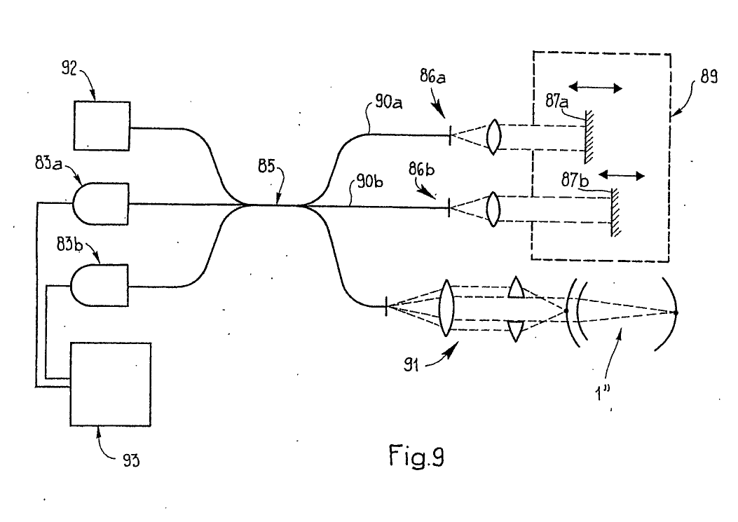

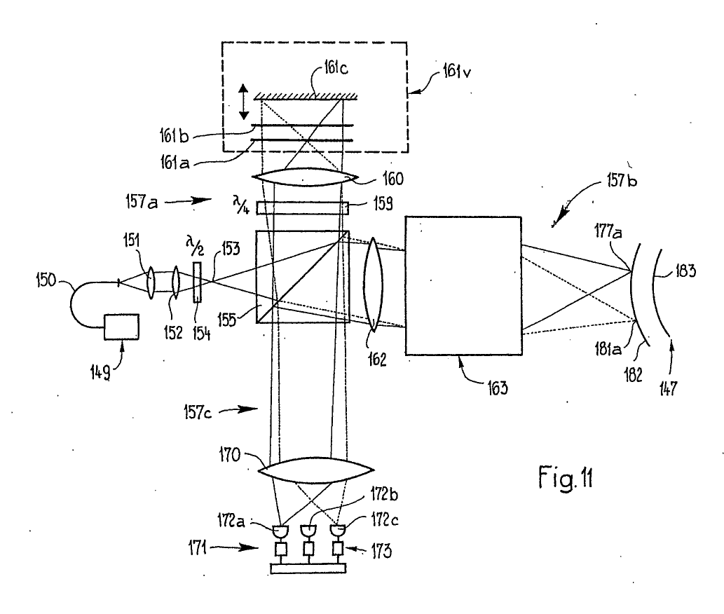

FIG. 9 shows a further variant of the measuring systems shown in FIGS. 4 and 7. Analogously to the illustration in FIG. 7, two detectors 83a and 83b are again used here. However, instead of the 2×2 fibre couplers 11 and 65a, 65b in FIGS. 4 and 7, respectively, a 3×3 fibre coupler 85 is used here. There are now also two reference arms 86a and 86b, into which in each case one and the same radiation is reflected back through the respective reflector 87a and 87b after a transit time change. The reflectors 87a and 87b are also adjustable relative to one another and are arranged on an oscillating base 89. The back-reflected radiation of each reflector 87a and 87b is coupled into the same fibre 90a and 90b, respectively, from which it has been issued. The short-coherent radiation issuing from a radiation source 92 is divided by the fibre coupler 85 into the measuring arm 91 and the two reference arms 86a and 86b. The measurement beam reflected in the measuring arm 91 from the areas in the object 1″, and the two reflected beam parts from the reference arms 86a and 86b, are superposed interfering in the fibre coupler 85, and then detected by the two detectors 83a and 83b and evaluated by the evaluation electronics 93 connected to these.

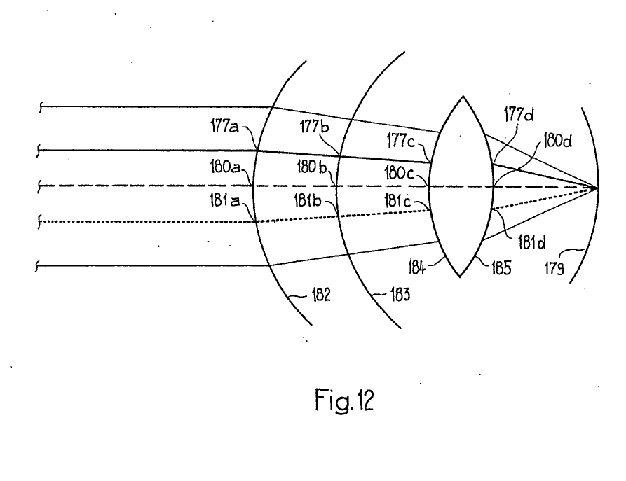

In FIGS. 4 to 9 described above, measurements are carried out to determine a thickness. To do this, the first measurement beam is focussed on a first area (point), and the second measurement beam is focussed on a second area (point) lying behind the first area. The first area and second area have hitherto been located on one optical axis. The device according to the invention can now be modified in such a way that the focus points of the two measurement beams lie next to one another. If the measurement beams are located laterally alongside one another, then it is possible to determine a surface profile on a surface having at least a minimum reflection factor of 10⁻⁴%. As is indicated in FIG. 10, this is done by determining the distance g₁ between a first reflecting site 97a of the first measurement beam 99a on the surface 100 and a reference point or reference plane 101, and the distance g₂ between the second reflecting site 97b of the second measurement beam 99b and the reference plane 101. Both measured values are stored in a memory in an electrical evaluation unit. The distance difference g₁ and g₂ of the two measurement beams 99a and 99b from the reference plane 101, in relation to their mutual spacing h, then yields two surface coordinates. These two coordinates can then be used to deduce the surface profile by approximation methods, as long as the nature of the surface is known. The nature of the surface is known in the case of the human eye. If several measurement beams are used or several measurements are carried out with laterally offset measurement beams, the surface can be more precisely determined.

In ophthalmology, when adapting intraocular lenses in cataract treatment, it is not only the eye length and anterior chamber depth that are important, but also the curve profile of the cornea, especially at the centre thereof. All these values can be determined using the device according to the invention.

To determine the profile, the minimum requirement is for two defined radii of curvature of the central cornea, namely a radius of curvature in the horizontal direction and one in the vertical direction. If these two radii are different, this is referred to as (central) astigmatism. The radii of curvature can be determined with the aid of known geometric algorithms if, as has already been stated, for each arc of a circle to be determined, the distance from a reference plane (here 101) at a predefined angle (here the normal distance g₁ and g₂) and the distance (here h) of the curve points (here 97a and 97b) from one another are known. The distances g₁ and g₂ can be determined from the instantaneous location of the reflector or reflectors or from the instantaneous angle of rotation of the path length variation unit (rotating cube) when interference phenomenon occurs. A predefined position of the reflectors or of the path variation unit is used as reference value. If a path length variation unit with a rotating cube (for example as described in WO 96/35100) is used, the reference used will preferably be its zero degree position at which the incident beam impinges perpendicularly on the first cube surface. Instead of a minimum of three measurement beams for determining the two central radii of curvature, it is also possible to use a larger number of measurement beams in order to obtain a more exact measurement of the radii of curvature. It is also possible for thickness and radius to be measured simultaneously, as is explained below.

The device shown in FIG. 11 on the basis of an optical block diagram is used for determining a surface profile and different thicknesses in a transparent or diffusive object, in this case a human eye 147. The optical structure shown schematically in FIG. 11 is in many respects similar to that in FIG. 4, the fibres here being replaced as an alternative by free-space beams. Here too, a radiation source 149 is present which, for example, can be a superluminescent diode. The radiation from the radiation source 149 is here guided via a fibre 150, permitting positional independence of the radiation source 149 and of the measurement and evaluation device. The radiation issuing from the fibre 150 is collimated by a lens 151 and focussed by a second lens 152 downstream. Arranged between the focus point 153 and the lens 152, there is a λ/2 plate 154 for “rotating” the polarization direction of the radiation. There then follows a beam splitter 155 with which the radiation is divided into the measuring arm 157b and the reference arm 157a. In the reference arm 157a, the beam splitter 155 is followed by a λ/4 plate 159, which is followed by a lens 160 with which the radiation from the beam splitter 155 is collimated. The lens 160 is followed by a first and second partially transparent reflector 161a and 161b and a 100% reflector 161c. All three reflectors 161a, 161b and 161c are adjustable relative to one another, according to the measurement to be carried out, and are arranged on an oscillating base 161v for the transit time change.

In the measurement arm 157b, the beam splitter 155 is followed by a collimation lens 162 and a lens system 163 analogous to the lens 21 in FIG. 4.

The radiation reflected back by the eye 147 is superposed by the reference radiation issuing from the reference arm 157a and, in the detector arm 157c, is guided via a lens 170 to a detector array 171; for the sake of simplicity, only a linear representation, not a two-dimensional representation, has been given of just three detectors 172a, 172b and 172c arranged close to one another. Each detector 172a, 172b, 172c is followed by an electronic circuit 173, for example with an amplifier, a Doppler frequency filter, rectifier and low-pass filter. The detected measurement signals are then processed by an analog-digital converter and a computer with memory and are presented on a screen.

With the device shown schematically in FIG. 11, the eye length, the corneal thickness, the anterior chamber depth, the lens thickness, the vitreous body depth and the retinal thickness can be measured simultaneously at different sites. Since it is possible to carry out measurements at different sites, surface profiles can also be determined by computation. To illustrate this, three laterally offset beam paths are shown in FIG. 12 by solid, dash and dotted lines, these being routed to the detectors 172a, 172b, 172c. The solid beam, shown enlarged in FIG. 12 for better clarity, comes from the sites 177a, 177b, 177c, 177d and the retina 179. Using a detector array consisting of m×n photodetectors, it is possible to simultaneously measure and evaluate m×n locations on or in the eye 147, e.g. on the anterior face 182 of the cornea, the posterior face 183 of the cornea, and the anterior face and posterior face 184 and 185, respectively, of the crystalline lens. After a certain time period, which is dependent on the speed of movement of the base 161v, the locations indicated by “b”, then by “c” and by “d” are detected and evaluated (see FIGS. 11 and 12).

Depending on the application, the lenses 160 and 162 can be designed as one-dimensional or two-dimensional lens array.

For better understanding of the measurement procedure, FIG. 11 also shows the “beam limits” to and from the site 177a as a solid line and to and from the site 181a as a dotted line in the reference, measuring and detector arm 157a, 157b and 157c. The solid and dotted lines show the two edge beams in the reference, measuring and detector arm 157a, 157b and 157c which permit the measurement of the spatial coordinates of the site 177a and 181a, respectively, i.e. which interfere with these beams.

procedure can of course also be done automatically by a control device.

The above-described device according to the invention, and its embodiment variants, can be used together with already existing apparatus. This device can, for example, be incorporated into or combined with a slit lamp apparatus for eye examination. The measurement beam, as free-space beam, can then be coupled either via beam splitters into the lighting beam path, in a microscope also via beam splitters into an observation beam path, or, in the microscope objective or with a deflection mirror 199, into a centre channel 200 of a stereo microscope 202 of a slit lamp apparatus, as is shown in FIG. 14. The centre channel 200 lies between the two beam paths 201a and 201b of the stereo microscope 202. A fixation light source 203 is also shown in FIG. 14. By looking at the fixation source 203, the patient directs his eye 205 at a predefined site and also keeps it there, in most cases also without movement. The measurement beam 206 emerges (analogously to a device configuration as shown in FIGS. 4, 7 and 9) from a fibre 207 and passes through a lens system 209, analogous to the lens system 17, with an optional transverse scanner. The other elements of the device according to the invention are incorporated in a compact base apparatus 210.

By moving the slit lamp apparatus in the three spatial coordinates, preferably with a so-called guide lever, the measurement beam is also correspondingly moved. Instead of moving the whole slit lamp apparatus together with the measurement beam, both can also be moved independently of one another. As has already been indicated above, when moving only the measurement beam, it is preferable to use a “fibre-optic” design analogous to the illustration in FIG. 4.

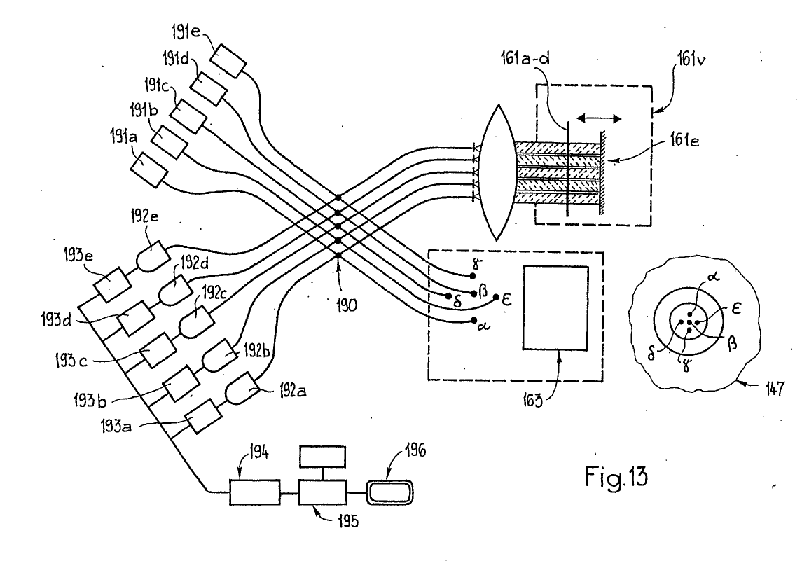

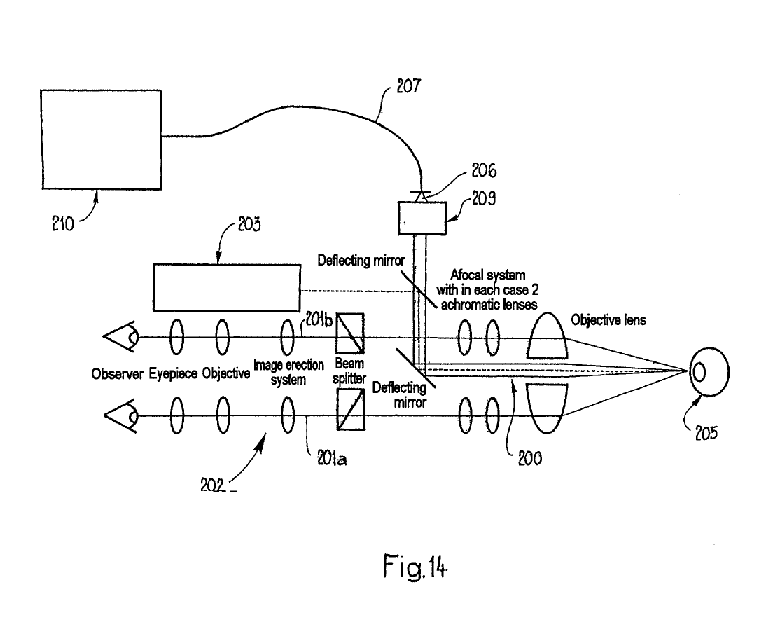

In a combination with a videokeratograph equipped with FIG. 13 shows a sketch of a device to be designated as a fibre-optic parallel short-coherent reflectometer. This embodiment variant of the invention permits, for example, simultaneous measurement of four central radii of curvature of the anterior surface of the cornea in a horizontal (left and right) direction and a vertical (up and down) direction. Simultaneous measurement of four central radii of curvature of the posterior face of the cornea is also possible. This arrangement has five 2×2 single-mode fibre couplers 190, five radiation sources 191a to 191e, five detectors 192a to 192e with associated circuitry 193a to 193e, analog-digital converter 194, computer 195 and display 196. The other elements and units (in particular 161a to 161e and 163) correspond to those of FIG. 11.

Instead of constructing an oscillating base for the reflector arrangement 161a to 161e, the above-described rotating cube can also be used, after the collimator lens, with a stepped mirror arrangement analogous to FIG. 6.

The position of the reflecting elements 31a/b, 49/50, 57a/b, 69a/b, 87a/b and 161 is in each case set for the object which is to be measured (here, in general, the eye, although other objects can also be measured). To find the optimal position of the reflecting elements in the reference arm, these elements can be arranged on a translation stage (not shown). With this stage, the reflecting elements are then moved in steps (e.g. in steps of 0.1 mm to 1 mm). After each step, the translation stage stops in order for a measurement to be carried out. Reflection signals are searched for by periodic scanning of a predefined depth by means of the path length variator (e.g. the path length variator 41, 55, 61, 71, 89, etc.). If no reflection signal has been found in this “depth scan”, the translation stage executes its next step. This procedure is repeated until suitable reflections are present. This search Placido discs, the measurement beam is coupled-in in the direction of the lighting axis of the videokeratograph with the aid of a small beam splitter.

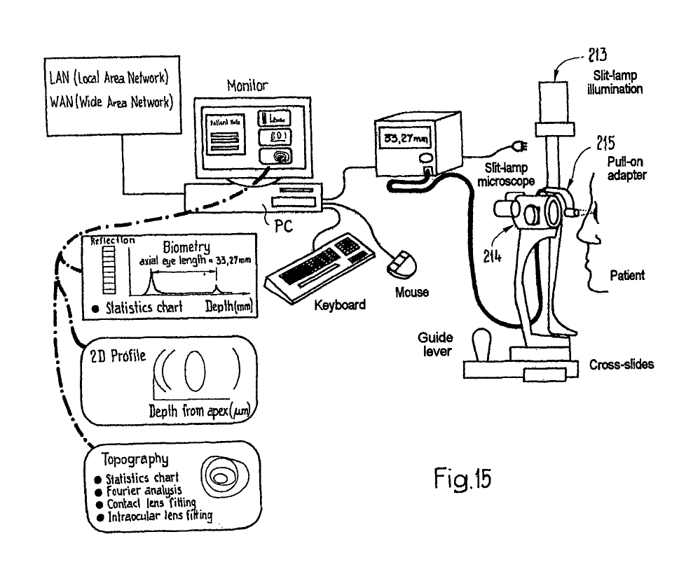

Instead of integrating the measurement beam path, as described above, into a stereo microscope, it can also be delivered in a slit lamp apparatus 213 via an adapter 215 which can be fitted onto the microscope 214, as is shown in FIG. 15.

In the embodiment variants described above, it generally holds true that all the beam splitters, whether fibre couplers or beam-splitting cubes, are configured as polarizing beam splitters. The radiation sources 9, 73, 149 and 191a to 191e also emit a polarized radiation in their source beam. Whenever interference is detectable, the lengths of the optical paths in the reference arm and in the measuring arm are the same length, the optical path length in the reference arm being able to change in the Hertz range. The lens system, e.g. 17, focussing the radiation in the measuring arm onto the areas concerned can be omitted in some applications. For example, for measurement of eye length, the focussing of the measurement beam can be taken over by the refractive power of the eye.

The optical transit time difference or optical transit time differences of the reflectors arranged in the reference arm are always set so as to correspond to an expected approximate measurement result. In other words, only the deviation from an expected measurement result is determined in each case by the measurement. Since these deviations are always much smaller than if the whole path (distance, thickness, etc.) has to be measured, it is possible to work with a much smaller and thus much faster path length variation (transit time change) in the reference arm. In terms of time, this means that the two interferences occur very rapidly one after the other; they may even occur simultaneously. Whereas, in distance measurements, thickness measurements, etc., the prior art always entailed two time-staggered measurements, the measurement result in the present invention is obtained so rapidly that positional shifts of the object to be measured affect the measurement precision only to an inappreciable extent.

The advantage just mentioned is of considerable benefit when carrying out eye length measurements on the eyes of children, who can generally be made to keep still only with difficulty.

If it is desired to assign the interferences to the reflecting surfaces concerned, then, instead of a single photodetector, it is possible to use two of them, one for each polarization direction. The radiation of one polarization direction is then directed by means of a polarizing beam splitter to one photodetector, and the radiation of the other polarization direction is directed to the other photodetector.

The radiation reflection may now be of a different level on or in one of the areas; there may also be a difference in reflections from areas within an object whose distance is to be determined or, where layers are concerned, whose thickness is to be determined. In order to be able to adapt the reflected intensity to a certain extent, λ/2 and λ/4 plates can be arranged, respectively, in the source beam and in the reference beam. The respective plate can now be adjusted in such a way that more intensity is coupled into the beam whose radiation is weakly reflected.

The path length change in the reference arm acts on the radiation frequency of the reference beam with a Doppler frequency f_{Doppler} according to the equation

$${f}_{Doppler} = \frac{2 \cdot {f}_{0} \cdot {v}_{scan}}{c}$$

where f₀ is the radiation frequency of the radiation source, v_{scan} is the path length change speed, and c is the light speed. (With the path length variation unit described in WO 96/35100, the Doppler frequency f_{Doppler} is approximately constant). This Doppler frequency also has the interference signal detected with the photodetector. The electrical signal obtained from the detector can thus be separated from the rest of the detected radiation with an electronic bandpass filter. The signal-to-noise ratio is considerably improved in this way.

The devices described above can be calibrated by means of the radiation of a high-coherence radiation source (e.g. a distributed feedback laser) being coupled into the reference arm with a beam splitter (not shown). The coupled-in radiation then interferes with a radiation part which is reflected on a fixed reflector at any desired site between this beam splitter and the path length variator. The coherence of the high-coherence radiation source is greater than the path variation length of the variator. An interference fringe pattern then runs via the detectors (or on a separate detector provided for this purpose). The distance between two interference fringes then corresponds in each case to a half path length. By means of (automatic) counting of these fringes, it is possible to calibrate the path of the path length variator. Since the high-coherence radiation cannot reach the patient's eye, its radiation power can be relatively high, so that this detection is not critical. The wavelength of the high-coherence radiation can (but does not have to) be of the same wavelength as the short-coherence radiation used for the eye measurement.

The thicknesses of the cornea which are determined with the above-described devices according to the invention can preferably be incorporated into a consultation with patients for whom the aim is to perform refractive surgery by LASIK (laser-assisted in situ kerato-mileusis), in which a calculation of a difference relating to the critical corneal thickness is performed individually in view of the relevant corneal thickness. The following novel steps are preferably undertaken for this purpose:
1. A preoperative central corneal thickness d_{z} is determined with one of the devices.
2. The mean flap thickness d_{f} customary for LASIK, of typically 160 μm, is subtracted (adjustably) from the determined corneal thickness d_{z}.
3. A (maximum possible) pupil diameter is determined while the eye is exposed to typical nocturnal conditions of light intensity. The “nocturnal pupil diameter” can be measured by darkening the examination room with a TV camera connected to the devices according to the invention or their embodiment variants. Such a camera can be docked, for example, in the detector arm via beam splitters with an appropriate lens system. The measurement of the pupil diameter is optional. Standard values can also be used for a consultation.

4. An optimum ablation diameter S is then stipulated for the cornea, this diameter having to be greater than the nocturnal pupil diameter, in order to avoid halo phenomena after the ablation.

5. The correction, in diopters, to be achieved with LASIK is known from previous measurements (for example from knowing the refractive power of an existing pair of spectacles or contact lenses already owned by the patient).
6. The central ablation depth to (in micrometres) required for the desired correction is calculated for the said desired correcton using the formula t₀=−(S²D)/3, S being the optimum ablation diameter in millimetres and D being the desired change in diopters as a consequence of the ablation.
7. The central stromal residual thickness dₛ=d_{z}−d_{f}−t₀ which would be obtained after the LASIK operation is now calculated.
8. It is ascertained whether the residual thickness ds is above a critical central stromal residual thickness dₖ. A possible definition for the critical central stromal residual thickness dₖ is, for example, dₖ=a·d_{z}−b, with a=0.58 and b=30 μm being adopted as standard values.
9. If, now, dₛ is greater than dₖ, it is possible to recommend a LASIK operation.

The processing steps set forth above can, of course, be automated via a computer.

The procedure takes place similarly in the case of correction of hyperopia. However, the corneal thickness must then be measured peripherally at the point of the maximum ablation; the formula specified under item 6 is then to be replaced appropriately.

The thickness and profile measurements on the eye as set forth above can be supplemented by determination of the refractive power distribution of the eye. In order to achieve this, the lens 162 in FIG. 11 is replaced by a lens array (not illustrated) with p×q lenses. The radiation coming from the radiation source 149 is thereby projected onto the eye in a fashion split into p×q component beams (not illustrated). The lens array can be moved up to the eye or away from the latter. It is now brought into a position such that focusing takes place at least partially on the retina. A further beam splitter is now used at a location between the surface of the eye and the lens 170, and the retina is viewed with a TV camera. If, now, the spatial distribution of the points of light on the retina deviates from the distribution of points generated by the lens array, the refractive power distribution or the image-forming property of the eye is not ideal, that is to say the eye does not form an optimal image of a plane wave front impinging on the cornea. This deviation (for example spherical aberration, coma, etc.) can then be displayed on a monitor.

Known tonometers (eye pressure measuring devices) have the disadvantage that they can measure the intraocular pressure only indirectly. The measurement is performed, for example, via a force which is necessary in order to flatten a corneal surface on a prescribed surface (applanation tonometer). The “flattening” force is, however, a function of the corneal thickness and the curvature of the cornea. The known tonometers proceed from a standardized normal corneal thickness and normal corneal curvature. In the case of a deviation of the cornea from the standard values, an intraocular pressure determined in such a way then does not correspond to the actual value. The thicker or the more strongly curved the cornea, the more the internal pressure determined in a known way deviates upwards from the actual value. This can lead to the administration of unnecessary or even harmful medicaments for lowering eye pressure, because of the supposedly excessively high eye pressure level. However, this faulty measurement or misinterpretation can also have the effect, for example, of delaying the diagnosis of glaucoma.

It is now proposed to combine the device according to the invention with a tonometer. The (“wrong”) intraocular pressure measured with a known tonometer is corrected computationally by using the corneal curvature and the corneal thickness determined with the device according to the invention. The correction can be performed by inputting the values into a computer, or automatically by electronically linking the two apparatus.

The devices according to the invention, their embodiment variants and their measuring instruments can be networked, it thereby being possible to undertake conditioning and storage of data even at remote locations and to compare them with other data.

As already mentioned in parts above, the device according to the invention serves the purpose of ophthalmological measurement of
the corneal thickness, the corneal thickness profile, the profiles of the anterior and posterior surfaces of the cornea;
the depth of the anterior chamber, the profile of the depth of the anterior chamber;
the lens thickness, the lens thickness profile, the profiles of the anterior and posterior surfaces of the lens,
the vitreous body depth, the vitreous body profile;
the retinal layer thickness, the retinal surface profile;
the epithelium thickness, the epithelium profile, the profiles of the anterior and posterior surfaces of the epithelium;
the corneal flap thickness, the flap thickness profile, the front and rear flap profiles, the flap position;
the corneal stroma thickness, the stroma profile, the front and rear stroma surface profiles.

Further measurements can be undertaken during post-operative follow-up examinations after refractive surgery.

1-9. (canceled)

10. Ophthalmological examination and/or treatment station for a human patient's eye (301) with an optical measuring arrangement (312, 311, 309, 131) and an evaluation unit (317) connected to the latter in signalling terms,
having a modular configuration,
said modular configuration having
a patient module (303),
an illuminating device (305),
a first optical fibre (304),
an observation device (325a/b, 326a/b, 315, 322, 323) and
a second optical fibre (309),
said patient module (303) being positioned directly in front of the human patient's eye (301) and being arranged remote from the evaluation unit (317),
said illuminating device (305) being likewise arranged remote from said patient module (303),
said patient module (303) being connected detachably by said first optical fibre (309) with said illuminating device (305),
said patient module (303) having at least one first fibre coupler part,
said first optical fibre (309) having a first counterpart adapted to the at least one first fibre coupler part for said detachable connection between the patient module (303) and the illuminating device (305),
said illuminating device (305) producing a first radiation conductable with said first optical fibre (304),
the patient module (303) having a first collimator (310a) interacting with the first optical fibre (304) for converting said first radiation into a first free-space beam (307),
said observation device (325a/b, 326a/b, 315, 322, 323) being arranged in the patient module (303) and preferably being connected detachably to the evaluation unit (317),
said optical measuring device (312, 311, 309, 313) having at least one second optical fibre (309) guiding a second radiation,
said patient module (303) having a second collimator (310b)
said second collimator (310b) converting said second radiation of said second optical fibre (309) into a second free-space beam (312),
said patient module (303) having at least one second fibre coupler part (311) and said second optical fibre having a second counterpart adapted to the at least one second coupler part for doing a detachable connection to said second collimator (310b).

11. Examination and/or treatment station according to claim 10, having a display element (315) being arranged on the patient module (303) and
having a detachable electrical signal line (316) for a detachable connection between the display element (315) and the evaluation unit (317).

12. Examination and/or treatment station according to claim 10, wherein the observation device (325a/b, 326a/b, 315, 322, 323) is designed with an eyepiece (323) arranged in the patient module (303) and with an objective lens (322) for eye examination.

13. Examination and/or treatment station according to claim 10,
wherein the observation device (325a/b, 326a/b, 315, 322, 323) has an image detecting element (CCD) (326a/b) and an optical unit (325a/b),
said optical unit (325a/b) projecting an area of the eye to be examined onto said image detecting element (326a/b),
the image detecting element (326a/b) and optical unit (325a/b) being arranged in the patient module (303).

14. Examination and/or treatment station according to claim 10, having a holding device (333) for the patient module (303).

15. Examination and/or treatment station according to claim 10, wherein said evaluation unit (317) being made computer-assisted for an evaluation or measurement of first data and
said station having data memories containing second retrievable data,
said optical measuring arrangement (312, 311, 309, 131) or said observation device (325a/b, 326a/b, 315, 322, 323) being connected to said evaluation unit (317) for evaluating measuring data,
said station having a data network for connecting said evaluation unit (317) with said data memories, whereby
said evaluation unit being able processing said first and said second data.

16. Examination and/or treatment station according to claim 10, wherein
said optical measuring arrangement (312, 311, 309, 131) being an optical arrangement of a Michelson interferometer type,
said optical measuring arrangement (312, 311, 309, 131) having a radiation source (9; 73; 92; 149; 191a-e) emitting said second radiation,
said second radiation being a short-coherent radiation,
said optical measuring arrangement (312, 311, 309, 131) being essentially a fibre-optical arrangement,
said optical measuring arrangement (312, 311, 309, 131) having a measuring branch (7; 72; 92; 157b),
said measuring branch having said second optical fibre (309),
said second optical fibre (309) transmitting a first part of said short-coherent radiation (second radiation),
said measuring branch having said second collimator (310b),
said first part of said short-coherent radiation (second radiation) being converted by said second collimator into said second free-space beam,
said free-space beam being directed at the human patient's eye as an optically transparent and/or diffusive reflecting object (1, 1′, 1″; 147; 205),
said optical measuring arrangement (312, 311, 309, 131) having a reference branch (5; 67; 86a, 86b; 157a),
said reference branch transmitting a second part of radiation of said short-coherent radiation,
said reference branch having a path length variation unit (39; 55; 61; 71; 89; 161v) for modifying a transit time of said second part of radiation in said reference branch;
said reference branch having two reflectors,
said reflectors dividing said second part of radiation in a third and in a forth part, whereby said forth part getting a first optical path length being different to a second optical path length to said third part,
said measuring branch having a measuring-branch-optical-fibre,
said measuring-branch-optical-fibre being disconnectable by fibre coupling devices.

17. Examination and/or treatment station according to claim 16 wherein said reference branch having at least two reflectors (31a, 31b; 49, 50; 57a, 57b; 87a, 87b; 161a-c; 161a-d),
said at least two reflectors are being retroreflectors.

18. Examination and/or treatment station according to claim 16, wherein
said optical measuring arrangement (312, 311, 309, 131) having an optical element (35; 61) in said reference branch (5), which element covers the reflectors (31a, 31b; 57a, 57b) in succession with said second radiation.

19. Examination and/or treatment station according to claim 13, wherein
said image detecting element (326a/b) and said optical unit (325a/b) are formed in a pair and
the pair parts are arranged at a distance from one another in order to permit stereoscopic observation.

20. Examination and/or treatment station according to claim 14, wherein
said holding device (333) being designed as an aligning device for positioning in front of the human patient's eye (301).

21. Examination and/or treatment station according to claim 10, wherein
said patient module (303) having a geometric design in the order of size of a contact lens in order to take up only a small area of space in front of the patient.

22. Examination and/or treatment station according to claim 10, wherein
said patient module (303) takes place only of just one apparatus but by its integration into said modular configuration achieving a functionality of a number of different individual apparatus.

23. Examination and/or treatment station according to claim 17, wherein
said at least two reflectors being offset in said reference branch at a different depth.

24. Examination and/or treatment station according to claim 17, wherein
said at least two reflectors being offset in said reference branch at a different depth and being movable with one another for generating together a transit time modification and transit time difference.
